(19) United States
(12) Patent Application Publication
(10) Pub. No.: US 2013/0290907 A1
(43) Pub. Date: Oct. 31, 2013

(54) CREATING AN OBJECT GROUP INCLUDING OBJECT INFORMATION FOR INTERFACE OBJECTS IDENTIFIED IN A GROUP SELECTION MODE

(71) Applicants: Chandar Kumar Oddiraju, Santa Clara, CA (US); Richard James Lawson, Santa Clara, CA (US); Marguerite Letulle, San Mateo, CA (US); Jared Ficklin, Austin, TX (US)

(72) Inventors: Chandar Kumar Oddiraju, Santa Clara, CA (US); Richard James Lawson, Santa Clara, CA (US); Marguerite Letulle, San Mateo, CA (US); Jared Ficklin, Austin, TX (US)

(21) Appl. No.: 13/459,583

(22) Filed: Apr. 30, 2012

(51) Int. Cl. G06F 3/048

(52) U.S. Cl. 715/845

(57) ABSTRACT

Examples disclosed herein relate to creating an object group including object information for interface objects identified in a group selection mode. Examples include activating a group selection mode and receiving identification of interface objects displayed in different interfaces of a graphical user interface (GUI) in the group selection mode.

### BACKGROUND

A computing device such as a notebook computer, tablet computer, mobile phone, or smart device may provide a graphical user interface (GUI) for user interaction with content of the computing device. In such examples, the computing device may enable a user to navigate between windows of the GUI and interact with content displayed in the windows using at least one input device, such as a mouse, a keyboard, a touch-sensitive display, or the like.

### BRIEF DESCRIPTION OF THE DRAWINGS

The following detailed description references the drawings, wherein:

FIG. 1 is a block diagram of an example computing device to create an object group based on interface objects identified in a group selection mode;

FIG. 2A is a diagram of an example graphical user interface (GUI) in which a user activates a group selection mode;

FIG. 2B is a diagram of a portion of an example GUI in which a user identifies a first interface object in a first interface for representation in a group;

FIG. 2C is a diagram of a portion of an example GUI in which a user identifies a folder in a second interface for representation in a group;

FIG. 2D is a diagram of a portion of an example GUI in which a user identifies an interface object on a desktop for representation in a group;

FIG. 2E is a diagram of a portion of an example GUI in which a user identifies an interface object in a window of an application for representation in a group;

FIG. 2F is a diagram of a portion of an example GUI in which a user deactivates the group selection mode;

FIG. 3 is a block diagram of an example computing device to maintain the selection of first interface object when a second interface object in a different interface is selected;

FIG. 4 is a flowchart of an example method for creating an object group representing objects identified in different interfaces of a GUI; and

FIG. 5 is a flowchart of an example method for performing an operation on an object group representing objects identified in different interfaces of a GUI.

### DETAILED DESCRIPTION

As noted above, a computing device may provide a graphical user interface (GUI) to enable a user to interact with content of the computing device using at least one input device, such as a mouse, a keyboard, a touch-sensitive display, or the like. In some devices, a user may select multiple different interface objects of the GUI to perform an operation on each of the selected interface objects, such as grouping, copying, or e-mailing the objects. However, in some examples, a user's selection of interface objects displayed in one interface (e.g., window, desktop, etc.) of the GUI may be lost when the user navigates to another interface. In such examples, a user may not be able to select interface objects to form into a group from different interfaces in a single operation.

In such examples, to group interface objects displayed in different interfaces of the GUI, a user may first create a temporary folder for storing the interface objects to be selected. Then, the user may navigate to a first interface of the GUI, select interface objects from the first interface, and copy the selected objects into the temporary folder. This process may then be repeated for each interface displaying a desired interface object. Once all desired objects have been copied into the temporary folder in this way, the user may navigate to an interface displaying the contents of the temporary folder and select all of the interface objects displayed there. A user may then create a group of the selected interface objects. However, this relatively complex process includes many different operations to collect desired interface objects from different interfaces of the GUI.

To address these issues, examples described herein may provide a group selection mode in which the selection of interface objects from different interfaces is maintained throughout the group selection mode. For example, after activation of the group selection mode, examples described herein may receive interactions identifying interface objects to be represented in a group, including interface objects displayed in different interfaces of a GUI. Examples described herein may then create an object group including information representing each of the interface objects identified in the group selection mode, including interface objects selected from different interfaces. In this manner, examples described herein may allow a user to more simply and quickly select interface objects from various interfaces of a GUI to create a group representing the selected interface objects.

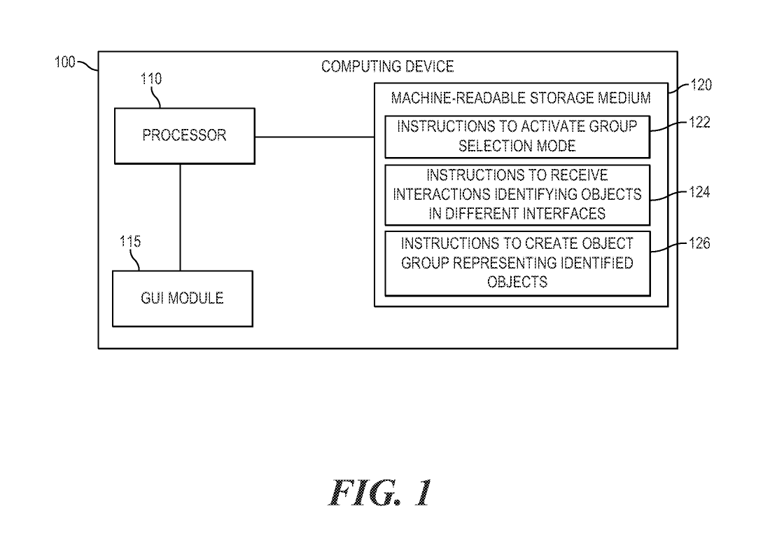

FIG. 1 is a block diagram of an example computing device to create an object group based on interface objects identified in a group selection mode. As used herein, a “computing device” may be a notebook computer, a desktop computer, an all-in-one computer, a tablet computer, a portable reading device, a mobile phone, a smart device, or any other device to implement a graphical user interface (GUI). In the example of FIG. 1, computing device 100 includes a processor 110, a GUI module 115, and a machine-readable storage medium 120 encoded with instructions 122, 124, and 126. In some examples, storage medium 120 may include additional instructions. In other examples, instructions 122, 124, 126, and any other instructions described herein in relation to storage medium 120 may be stored remotely from computing device 100.

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processor 110 may fetch, decode, and execute instructions stored on storage medium 120 to implement the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage device to contain or store information such as executable instructions, data, and the like. For example, any machine-readable storage medium described herein may be any of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. Further, any machine-readable storage medium described herein may be non-transitory.

In the example of FIG. 1, GUI module 115 may implement a GUI on computing device 100. GUI module 115 may output the GUI on a display of computing device 100 and receive input via input devices of computing device 100. Input devices of computing device 100 may include, for example, at least one of a mouse, a keyboard, a touch-sensitive display, or any other device suitable for providing input via interaction with the GUI. In some examples, the functionalities of GUI module 115 may be implemented in the form of executable instructions encoded on a machine-readable storage medium, in the form of electronic circuitry, or a combination thereof. In some examples, GUI module 115 may be implemented as part of an operating system (OS) of computing device 100, wherein the OS is implemented in the form of instructions executable by processor 110. Additionally, GUI module 115 may include at least one display driver for outputting the GUI on at least one display of computing device 100, and at least one input device driver to receive input via at least one input device of computing device 100.

In operation, GUI module 115 may output (e.g., display) at least one interface of the GUI on a display of computing device 100. As used herein, an “interface” of a GUI of a computing device is a graphical area of the GUI output by the computing device that is associated with a set of interface objects for display in the graphical area to allow interaction with the interface objects via at least one input device. Example interfaces of a GUI may include a desktop, a window (e.g., a window for an application, a window displaying the contents of a folder or other directory, etc.), and the like.

As used herein, “different” interfaces of a GUI are interfaces that are each associated with a different set of interface objects for display. Different copies of an interface object may be considered different interface objects herein. In examples described herein, different interfaces may include, for example, a desktop and a window, windows associated with different sets of interface objects (e.g., windows for different folders or directories), windows for different applications, a window associated with the contents of a folder and a window for an application, and the like. In such examples, the different interfaces may be interfaces with different boundaries (e.g., different windows, a desktop and a window, etc.). In some examples, a window (or other interface) may be associated with more interface objects than are displayed at one time. In such examples, the window may be scrolled or otherwise operated to view other interface objects associated with the window while remaining within the same interface.

As used herein, an “interface object” is a graphical representation of content displayed by a GUI that is selectable with an input device. Example interface objects include files of any type (e.g., word-processing, image, audio, video, or other media files, etc.), file directories, applications, shortcuts to any type of content, hyperlinks, uniform resource locators (URLs), and the like. In some examples, some interface objects may be displayed by the GUI using icons. In examples described herein, GUI module 115 may also display other features (e.g., buttons, menus, and the like) that may be operated via an input device.

In the example of FIG. 1, instructions 122 may activate a group selection mode in response to operation of a group selection start feature of a GUI of computing device 100. In examples described herein, a group selection start feature may be, for example, a button, a checkbox, a menu item (e.g., a context menu item, etc.), a gesture defined in the GUI or any other type of feature of the GUI that may be operated with an input device. A user may operate the group selection start feature using an input device of computing device 100. For example, a user may operate the start feature by clicking on the start feature using a mouse, by tapping on the start feature (e.g., with a finger or stylus, etc.) when it is displayed on a touch-sensitive display of computing device 100, or the like. In examples in which the start feature is a gesture, a user may operate the start feature by performing the predefined gesture with a finger (or stylus, etc.) on a touch-sensitive display, or with another input device (e.g., a mouse, etc.). As used herein, a “group selection mode” is a mode in which a computing device is to receive object information for at least one interface object to be represented in an object group in response to respective interactions with each of the at least one interface object.

In the group selection mode (i.e., after activation of the group selection mode), instructions 124 may receive respective interactions with a plurality of interface objects, each interaction identifying an interface object to be represented in a group. At least two of the interface objects identified in the group selection mode may be displayed in different interfaces of the GUI. For example, after activation of the group selection mode, instructions 124 may receive interactions with first and second interface objects identifying the first and second interface objects for representation in a group, wherein the first and second interface objects are displayed in different interfaces, such as different windows, different applications, a window and a desktop, or the like. Instructions 124 may maintain a list or other record of the interface objects identified in the group selection mode, including interface objects identified in different interfaces of the GUI.

In some examples, each interaction identifying an interface object for representation in a group may include clicking on the interface object, tapping the interface object, or any other suitable type of action performed on the interface object with an input device. In such examples, when input is received from an input device, an OS of computing device 100 may provide to instructions 124 an Application Programming Interface (API) message indicating the type of action and the coordinates of the action, for example. If instructions 124 determine that the action (e.g., the click, tap, etc.) was performed at coordinates where an interface object is displayed, instructions 124 may determine that the input is an identification of an interface object for representation in a group. In some examples, in the group selection mode, instructions 124 may distinguish interactions with interface objects from interactions with other features of the GUI (e.g., a menu, a button, a scroll bar, etc.), and receive the interactions with interface objects as identifications of objects to be represented in a group while ignoring interactions with other features of the GUI.

In other examples, instructions 124 may receive respective group selection actions performed on interface objects as identifications of the interface objects for representation in a group. In such examples, instructions 124 may determine that an interface object has been identified for representation in a group when a defined group selection action is performed on the interface object in the group selection mode, and ignore interactions other than the group selection action. In examples described herein, a group selection action is a defined act to be performed with an input device act to identify interface objects for representation in a group in the group selection mode.

In some examples, the group selection action may be different than each navigation action of the GUI so that instructions 124 may distinguish the group selection action from other input device actions. For example, the group selection action may be defined as a tap or click action that is held for a given period of time. The given period of time may be, for example, 1.5 seconds, 2 seconds, or any other duration suitable for a particular implementation. In such examples, the held click or tap may be distinguished from a single or double click (or tap) action, as well as from a click or tap held for a different period of time. For example, if a GUI displays a context menu in response to a tap or click held for a first amount of time (e.g., 4 seconds), then the group selection action may be defined as a click or tap action held for a different amount of time (e.g., about 1.5 seconds). In other examples, the group selection action may be a defined gesture that may be performed with a finger (or stylus, etc.) on a touch-sensitive display, or with another input device (e.g., a mouse, etc.). In some examples, the gesture may be defined as a gesture different than any other gesture defined for the GUI.

Instructions 124 may detect the group selection action based on API messages received from the OS of computing device 100. For example, instructions 124 may receive an API message when a click or tap starts (and the coordinates of the action) and receive another API message when the click or tap ends (and the corresponding coordinates). Using this information, instructions 124 may determine whether the click or tap was held on the coordinates of an interface object for the amount of time defined for the group selection action. In other examples, the group selection action may be the selection of an item in a context menu that may be invoked for a given interface object by, for example, performing a held click or tap on the interface object long enough to invoke the context menu.

By defining a distinct group selection action for identifying interface objects in the group selection mode, examples described herein may distinguish between actions for identifying interface objects for group representation and actions for navigating between different interfaces. For example, a group selection action performed on an interface object such as a folder may identify the folder for representation in the group, whereas performing a single or double click (or tap) action on the folder may open the folder to display its contents without selecting the folder. In this manner, examples described herein may allow a user to both navigate between interfaces and select items from different interfaces for representation in the group in the group selection mode.

In the example of FIG. 1, in response to a group creation request, instructions 126 may create an object group including object information for each of the interface objects identified, in the group selection mode, for representation in a group. As used herein, an “object group” is a module including object information representing each of at least one interface object, wherein requesting to perform an operation on the module causes the operation to be performed on object information for each interface object represented in the module. As used herein, “object information” for an interface object may be a copy of the interface object, information referencing the interface object (e.g., a link, a pointer, an address, etc.), content included in the interface object (e.g., text, etc.), or any other information associated with or identifying the interface object.

In some examples, instructions 126 may deactivate the group selection mode in response to operation of a group selection end feature of the GUI. The group selection end feature may be similar to the group selection start feature described above. For example, the group selection end feature may be a button, a checkbox, a menu item (e.g., of a context menu, etc.), or any other type of feature displayed by the GUI that may be operated with an input device. A user may operate the group selection end feature using an input device of computing device 100, as described above in relation to the group selection start feature. In some examples, operation of the group selection end feature may also generate the group creation request.

In other examples, instructions 126 may receive the group creation request in response to operation of a group creation feature of the GUI. The group creation feature may be a button, a checkbox, a menu item (e.g., of a context menu, etc.), or any other type of feature displayed by the GUI that may be operated with an input device. For example, the GUI may display a context menu in response to the operation of the group selection end feature, and the group creation feature may be a menu item in the context menu.

Additionally, in some examples, instructions 126 may create an object group for a particular type of interface object. In such examples, instructions 122 may request selection of an object group type in response to the operation of the group selection start feature. For example, in response to the group selection start feature, instructions 122 may display a menu of available object group types and receive a selection of one of the object group types in response to interaction with the menu via an input device. Object group types may include, for example, a folder group for folders or other content directories, a file group for media files (e.g., documents, images, audio, etc.), particular file groups (e.g., a group for image files, a group for audio files), a text group for a textual aspect of each indentified interface object, and the like.

In examples in which instructions 122 receive a selection of an object group type, instructions 124 may receive respective interactions with interface objects of the type associated with the selected object group type and ignore interactions with interface objects of a type not associated with the selected object group type. For example, instructions 124 may, in response to interaction with an interface object of a type associated with the selected group type, add object information for the interface object to a list of identified interface objects. In such examples, instructions 124 may not add object information to the list for any interface object of a type not associated with the selected object group type. In some examples, if a file group is selected, instructions 124 may receive interactions with media files (e.g., document files, audio files, etc.) as identifying an interface object to be represented in a group and ignore interactions with folders. In such examples, instructions 124 may allow a user to identify files for representation in a group in the group selection mode while allow a user to open folders without selecting them for representation in the group.

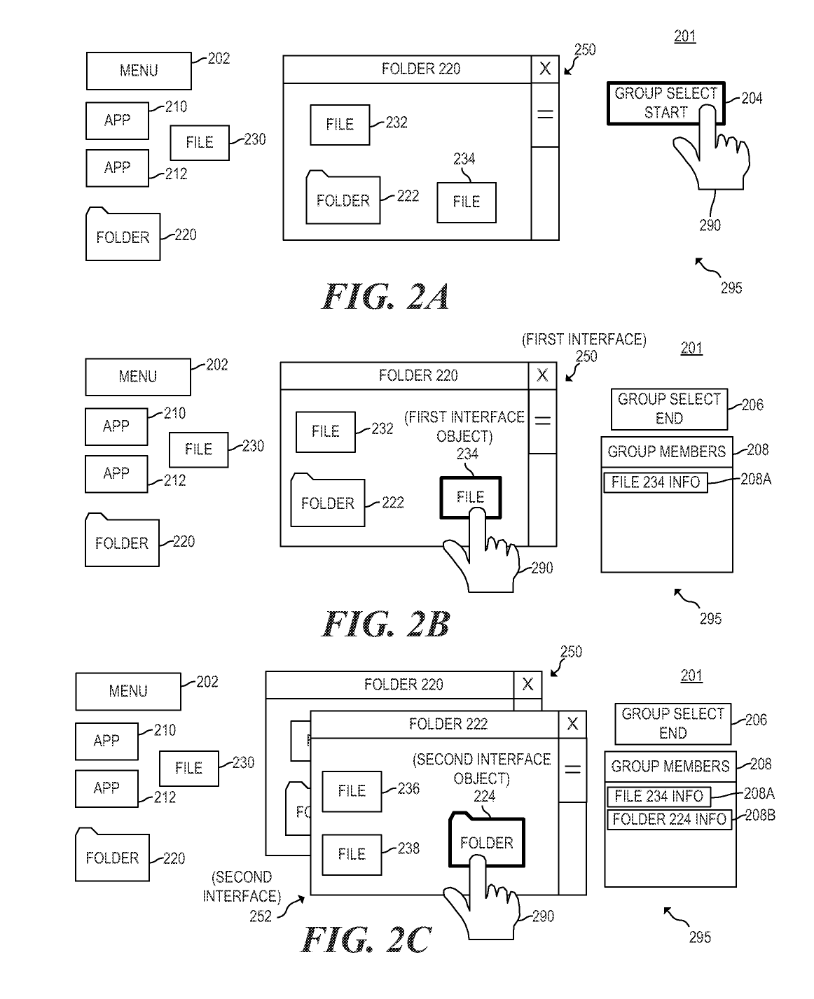

In some examples the selected object group type may be a text group. In such examples, computing device 100 may collect text associated with each interface object selected in the group selection mode. For example, in response to the selection of a media file (e.g., via interaction with the media file in the group selection mode), instructions 124 may store the location at which the media file is stored. As another example, in response to the selection of a hyperlink, instructions 124 may store the URL associated with the hyperlink. In such examples, in response to each interaction with an interface object in the group selection mode, instructions 124 may store a textual aspect of the interface object identified via the interaction. As used herein, a “textual aspect” of an interface object is information associated with the interface object and maintained in a text format. After objects for the text group are selected, instructions 126 may create the text group in response to a group creation request. In such examples, an operation performed on the text group may cause that operation to be performed on the text included in the group. For example, copying the text group into an e-mail may cause the gathered text (e.g., file locations, URLs, etc.) of the text group to be copied into the body of the e-mail. In some examples, textual aspects of interface objects may be stored by instructions 124 on storage medium 120 or on another machine-readable storage medium of computing device 100. In some examples, functionalities described herein in relation to FIG. 1 may be provided in combination with functionalities described herein in relation to any of FIGS. 2A-5.

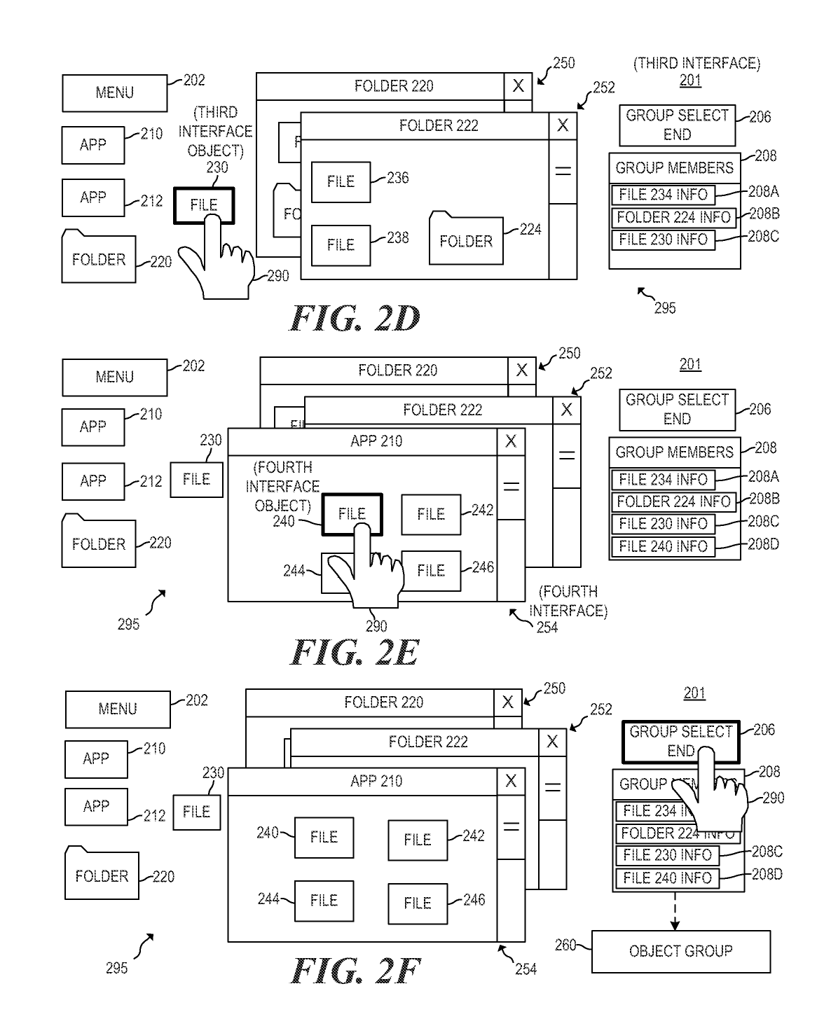

FIG. 2A is a diagram of a portion of an example graphical user interface (GUI) 295 in which a user activates a group selection mode. In some examples, GUI 295 may be output (e.g., displayed) on at least one display of computing device 100 of FIG. 1. Also, in some examples, the functionalities described below in relation to FIGS. 2A-2F may be implemented by GUI module 115 and instructions 122, 124, and 126 of computing device 100. Although the examples of FIGS. 2A-2F are described herein with reference to computing device 100 of FIG. 1, other suitable components for implementation of GUI 295 can be utilized (e.g., computing device 300 of FIG. 3).

The portion of GUI 295 illustrated in FIG. 2A displays different interfaces, namely a desktop 201 and a window 250. As shown in FIG. 2A, desktop 201 displays a menu feature 202, a group selection start feature 204, applications 210 and 212, a file 230, and a folder 220. In the example of FIG. 2A, window 250 displays the contents of folder 220, which include files 232 and 234, and a folder 222. In the example of FIG. 2A, a user may operate group selection start feature 204 using an input device of computing device 100. For example, a user may use a mouse to click on feature 204 with a pointer 290 that may be shown on a display of computing device 100. Although pointer 290 has the shape of a hand in FIGS. 2A-2F, in other examples, pointer 290 may have any other suitable shape (e.g., an arrow, etc.). In other examples, a user may operate feature 204 by tapping feature 204 when it is displayed on a touch-sensitive display of computing device 100. In such examples, pointer 290 may not be shown on a display of computing device 100. In other examples, feature 204 may be operated using any other suitable input device action, any other suitable input device of computing device 100, or a combination thereof. Although the examples of FIGS. 2A-2F use a pointer 290 to illustrate user input, in some examples, user input may be received via an input device without a pointer 290 being displayed by computing device 100 (e.g., when input is received via a touch-sensitive display). As described above in relation to FIG. 1, operation of group selection start feature 204 may activate a group selection mode of computing device 100.

FIG. 2B is a diagram of a portion of an example GUI 295 in which a user identifies a first interface object in a first interface for representation in a group. In the example of FIG. 2B, after operating group selection start feature 204, a group selection end feature 206 and a list 208 of group members may be displayed in the group selection mode. In other examples, one or both of feature 206 and list 208 may not be displayed. For example, a group selection end feature 206 may be listed in menu 202 or be included in a context menu invoked by interacting with desktop 201 in the group selection mode. In some examples, computing device 100 may maintain list 208 (e.g., in memory) without displaying list 208.

As shown in FIG. 2B, a user may interact with a first interface object, namely file 234, in the group selection mode to identify file 234 for representation in a group. In the example of FIG. 2B, file 234 is displayed in window 250 (i.e., a first interface) displaying the contents of folder 220. In some examples, in response receiving the interaction with file 234, as described above in relation to FIG. 1, computing device 100 may store object information 208A for file 234 in list 208, as shown in FIG. 2B. The interaction with file 234 may be a group selection action performed on file 234 or any other suitable of action performed on file 234 with an input device, as described above in relation to FIG. 1.

FIG. 2C is a diagram of a portion of an example GUI in which a user identifies a folder 224 in a second interface for representation in a group. In the example of FIG. 2C, after identifying file 234 displayed in window 250 (i.e., the first interface) in the group selection mode, a user may navigate to a second interface, such as a window 252 displaying contents of a folder 222. A user may navigate to window 252 by opening folder 222 by, for example, performing an appropriate action (e.g., a single or double click or tap) on folder 222 displayed in window 250 with an input device. In examples in which interface objects are identified for group representation using a defined group selection action, the action for opening folder 222 may be different than the group selection action. For example, the group selection action used to identify interface objects (e.g., file 234, etc.) for group representation may be a tap action held for a threshold amount of time (e.g., 1.5 seconds, etc.), while the action to open a folder, such as folder 222, may be a double tap or a single tap held for less than the threshold amount of time.

As shown in FIG. 2C, after opening window 252 for folder 222, a user may interact with a second interface object, namely folder 224, in the group selection mode to identify folder 224 for representation in a group. In response to receiving the interaction with folder 224, computing device 100 may store object information 208B for folder 224 in list 208 along with object information 208A for file 234 previously identified in a different interface. In some examples, folder 224 may be identified using the defined group selection action so that folder 224 is identified for representation in a group and not opened. As shown in FIG. 2C, in the group selection mode, computing device 100 maintains in list 208 the object information 208A for file 234 displayed in a first interface (i.e., window 250) when a subsequent interaction identifying folder 224 displayed in a second interface (i.e., window 252) different than the first interface is received.

In other examples, different interfaces may be sequentially displayed within the same window, or within different windows presented so as to appear to be the same window. For example, if a first interface displaying the contents of a first folder is displayed in a given window, a second interface displaying the contents of a second folder may subsequently be displayed in the given window. In other examples, a new window for the second interface may replace the window displaying the first interface when the second folder is opened. As one example, in response to opening folder 222 displayed in window 250, window 250 may change from displaying the contents of folder 220 to displaying the contents of folder 222. In some examples, window 250 displaying the contents of folder 222 may be considered a different interface than window 250 displaying the contents of folder 220. In such examples, window 250 may transition from an interface for folder 220 to a different interface for folder 222, when folder 222 is opened. In such examples, the identification of interface objects identified in these different interfaces may be received and maintained in the group selection mode as described herein in relation to the identification of interface objects displayed in different windows, for example.

FIG. 2D is a diagram of a portion of an example GUI in which a user identifies an interface object on a desktop 201 for representation in a group. In the example of FIG. 2D, after identifying folder 224 in window 252 (i.e., the second interface) in the group selection mode, a user may interact with a file 230 (i.e., a third interface object) displayed on desktop 201 (i.e., a third interface) to identify file 230 for representation in a group. In response to receiving the interaction with file 230, computing device 100 may store object information 208C for file 230 in list 208. As shown in FIG. 2D, object information 208A and 208B for file 234 and folder 224, respectively, are maintained in list 208 when a user identifies file 230 displayed on desktop 201, which is an interface different than each of the respective interfaces displaying file 234 and folder 224.

FIG. 2E is a diagram of a portion of an example GUI in which a user identifies an interface object in a window 254 of an application for representation in a group. In the example of FIG. 2E, after identifying file 230 displayed on desktop 201 (i.e., a third interface), a user may navigate to or open a fourth interface, such as a window 254 for an application 210. Application 210 may be, for example, an application for interaction with media files (e.g., viewing image files, playing audio files, etc.) or any other type of application displaying at least one interface object. In examples in which interface objects are identified for group representation using a defined group selection action, the action for opening application 210 may be different than the group selection action, as described above in relation to FIG. 2C.

As shown in FIG. 2E, after opening window 254 for application 210, a user may interact with a fourth interface object displayed in window 254, namely file 240, in the group selection mode to identify file 240 for representation in a group. In response to receiving the interaction with file 240, computing device 100 may store object information 208D for file 240 in list 208 along with object information 208A, 208B, and 208C for file 230, file 234, and folder 244, respectively, each of which is displayed in a different interface than window 254. In such examples, computing device 100 may maintain the identification of four interface objects, each displayed in a different interface, in list 208 in the group selection mode. Although examples described herein in relation to FIGS. 2A-2E illustrate one interface object being identified in each of the illustrated interfaces, in other examples, multiple interface objects may be identified in any of the interfaces. Also, in some examples, interface objects may be selected from the different interfaces in any order.

FIG. 2F is a diagram of a portion of an example GUI in which a user deactivates the group selection mode. In the example of FIG. 2F, a user may operate group selection end feature 206 using an input device of computing device 100. Feature 206 may be operated using any suitable action via any suitable input device, as described above in relation to FIG. 2A. As described above in relation to FIG. 1, operation of group selection end feature 206 may deactivate the group selection mode of computing device 100. Also in response to operation of end feature 206, or in response to a separate group creation request after operation of end feature 206, computing device 100 may create an object group 260 including object information for each of the interface objects identified in the group selection mode for representation in a group. For example, computing device 100 may create an object group based on the object information included in list 208, or based on the interface objects identified by the object information included in list 208. In the example of FIG. 2F, object group 260 may include object information for each of file 230, file 234, file 240, and folder 224, each displayed in a different interface of GUI 295, as described above in relation to FIGS. 2B-2E. In some examples, after creating object group 260, an icon or other visual representation of object group 260 may be displayed in the GUI, such as on desktop 201. The visual representation of object group 260 may include images representing at least one of the interface objects represented in the group in a circular, cascaded, layered, or other suitable manner.

FIG. 3 is a block diagram of an example computing device 300 to maintain the selection of first interface object when a second interface object in a different interface is selected. In the example of FIG. 3, computing device 300 may comprise a processor 110 and a GUI module 115, as described above in relation to FIG. 1. Computing device 300 may also comprise a display 317, storage 340, and a group selection module 330, including modules 332, 334, 336, and 338. In some examples, module 330 may include additional modules. The functionalities of group selection module 330, including the functionalities of modules 332, 334, 336, and 338, may be implemented in the form of executable instructions encoded on a machine-readable storage medium, in the form of electronic circuitry, or a combination thereof. Storage 340 may be a machine-readable storage medium.

In the example of FIG. 3, GUI module 115 may output a GUI on display 317 of computing device 300. Display 317 may be at least one monitor, screen, or other combination of hardware components capable of outputting video signals received from processor 110 or any other component of computing device 300. In some examples, display 317 may be a touch-sensitive display capable of outputting video signals and receiving user input in the form of touch.

Activation module 332 may activate a group selection mode in response to operation of a group selection start feature of the GUI, as described above in relation to FIG. 1. In the group selection mode, selection receipt module 334 may receive respective interactions with interface objects displayed in respective interfaces of the GUI, each interaction in the group selection mode identifying an interface object to be represented in a group. In some examples, each of the interactions may be any suitable type of interaction performed on an interface object with an input device, as described above in relation to FIG. 1. In other examples, module 334 may receive respective group selection actions performed on interface objects as identifications of interface objects to be represented in a group, as described above in relation to FIG. 1.

In some examples, the group selection action may be different than each navigation action of the GUI. In such examples, module 334 may distinguish the group selection action from other input device actions. Additionally, in some examples, the group selection action may be performed with a single input device, such as a mouse, a keyboard, a touch-sensitive display, or any other suitable input device. For example, the group selection action may be a held click action, as described above in relation to FIG. 1, which may be performed with a single input device, such as a mouse, or the like. In other examples, the group selection action may be a held tap action, as described above in relation to FIG. 1, which may be performed with a single input device, such as a touch-sensitive display.

Additionally, selection maintenance module 338 may maintain a list 342 of interface objects identified in the group selection module for representation in a group. For example, module 334 may receive an interaction with a first interface object, displayed in a first interface of the GUI in the group selection mode, wherein the interaction identifies the first interface object to be represented in a group. In response, module 338 may add object information for the first interface object to list 342. In some examples, module 338 may maintain the list 342 in storage 340. In some examples, list 342 may be the list 208 described above in relation to FIGS. 2B-2F.

In some examples, after receiving the interaction with the first interface object, module 334 may receive a subsequent interaction with a second interface object displayed in a second interface of the GUI in the group selection mode, the subsequent interaction identifying the second interface object to be represented in a group. In response to the subsequent interaction, module 338 may add object information for the second interface object to list 342. In such examples, module 338 may maintain the object information for the first interface object (of the first interface) in list 342 when the subsequent interaction with the second interface object (of the second interface) is received by module 334 in the group selection mode. In this manner, module 338 may maintain a first identification of an interface object displayed in a first interface when a subsequent interaction identifying an interface object displayed in a second interface is received by module 334 in the group selection mode.

In the example of FIG. 3, the first and second interfaces may be any two different interfaces of the GUI of computing device 300. For example, the first and second interfaces may be first and second windows of the GUI. One such example is illustrated in FIGS. 2B and 2C. In other examples, the first interface may be a window of the GUI and the second interface may be a desktop of the GUI. One such example is illustrated in FIGS. 2C and 2D. In such examples, the first interface may be a window 252 displaying the contents of a folder 222 including the first interface object (e.g., folder 224). The second interface may be desktop 201 of the GUI, where desktop 201 includes the second interface object (e.g., a file 230). In such examples, module 334 may receive the interactions with the first and second interface objects identifying them for representation in a group, and module 338 may maintain object information for the first interface object (e.g., folder 224) when a subsequent interaction with the second interface object (e.g., file 230) is received by module 334.

In still other examples, the first and second interfaces may be windows displaying first and second applications of computing device 300. In such examples, the first interface may be a window for a first application (such as window 254 of FIG. 2E) in which the first interface object is displayed. The second interface may be a window for a second application in which the second interface object is displayed. In such examples, module 334 may receive the interactions with the first and second interface objects identifying them for representation in a group, and module 338 may maintain object information for the first interface object when a subsequent interaction with the second interface object is received by module 334.

In the example of FIG. 3, in response to a group creation request, creation module 336 may create an object group including object information for the interface objects identified, in the group selection mode, to be represented in a group. Module 336 may receive the group creation request in response to operation of a group selection end feature of the GUI or a separate group creation feature of the GUI, as described above in relation to FIG. 1. In some examples, module 336 may create an object group including object information for each of the interface objects identified in list 342 maintained by module 338. In such examples, module 336 may create an object group that includes the object information maintained in list 342. In other examples, module 336 may use list 342 to identify each of the interface objects to be represented in the object group and include other object information for at least one of the identified interface objects in the object group, either in addition to or instead of the object information included in list 342. In some examples, functionalities described herein in relation to FIG. 3 may be provided in combination with functionalities described herein in relation to any of FIGS. 1-2F and 4-5.

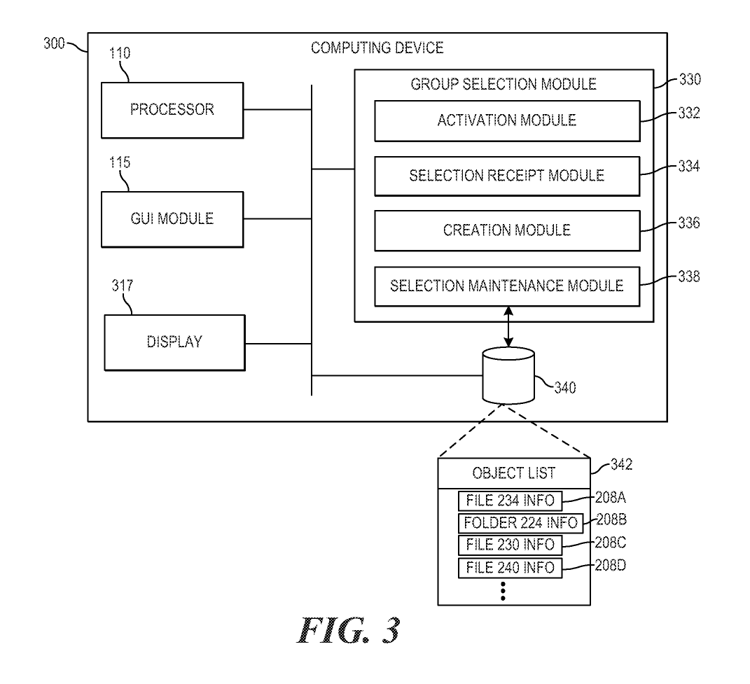

FIG. 4 is a flowchart of an example method 400 for creating an object group representing objects identified in different interfaces of a GUI. Although execution of method 400 is described below with reference to computing device 100 of FIG. 1, other suitable components for execution of method 400 can be utilized (e.g., computing device 300). Additionally, method 400 may be implemented in the form of executable instructions encoded on a machine-readable storage medium, in the form of electronic circuitry, or a combination thereof.

At 405 of method 400, computing device 100 may activate a group selection mode in response to operation of a group selection start feature of a GUI output on a display of computing device 100. The group selection start feature may be operated via an input device of computing device 100. At 410, computing device 100 may receive an identification of a first interface object in response to a group selection action performed, in the group selection mode, on the first interface object displayed in a first interface of the GUI. In some examples, the group selection action may be different than each navigation action of the GUI, as described above in relation to FIG. 1. Performance of the group selection action on an interface object may be received by computing device 100 as an identification of the interface object for representation in a group.

At 415, computing device 100 may receive a request to navigate to a second interface of the GUI. The request may be received by the computing device 100 in the form of a navigation action performed with at least one input device of computing device 100. For example, the first and second interfaces may be different windows of the GUI. In such examples, the navigation request may be a received in the form of a single or double click or tap on an icon to request that computing device 100 open a window, application, or other interface associated with the icon.

At 420, computing device 100 may receive a subsequent identification of a second interface object in response to a group selection action performed, in the group selection mode, on the second interface object displayed in the second interface. In such examples, computing device 100 may receive, in the group selection mode, respective identifications of interface objects displayed in different interfaces of the GUI of computing device 100 in response to respective group selection actions performed on interface objects. At 425, in the group selection mode, computing device 100 may maintain the identification of the first interface object when the subsequent selection of the second interface object is received. For example, computing device 100 may maintain a list of interface objects identified in the group selection mode, as described above in relation to list 208 of FIGS. 2B-2F and list 342 of FIG. 3. In such examples, computing device 100 may maintain object information for the first interface object in the list when the second interface object, displayed in the second interface, is identified with a group selection action.

At 430, in response to a group creation request, computing device 100 may create an object group including object information for the interface objects identified in the group selection mode. In some examples, the group creation request may be received in response to the operation of a group selection end feature of the GUI, which may also deactivate the group selection mode. In other examples, the group creation request may be received in response to the operation of a group creation feature of the GUI after operation of the group selection end feature. In some examples, in response to the group creation request, computing device 100 may create an object group including object information for each of the interface objects identified in the list of identified interface objects. In some examples, the object group may include the object information maintained in the list for each identified interface objects. In other examples, the object information in the list may be used to identify the selected interface objects, and other object information for the selected interface objects may be included in the object group in addition to or instead of the information included in the list.

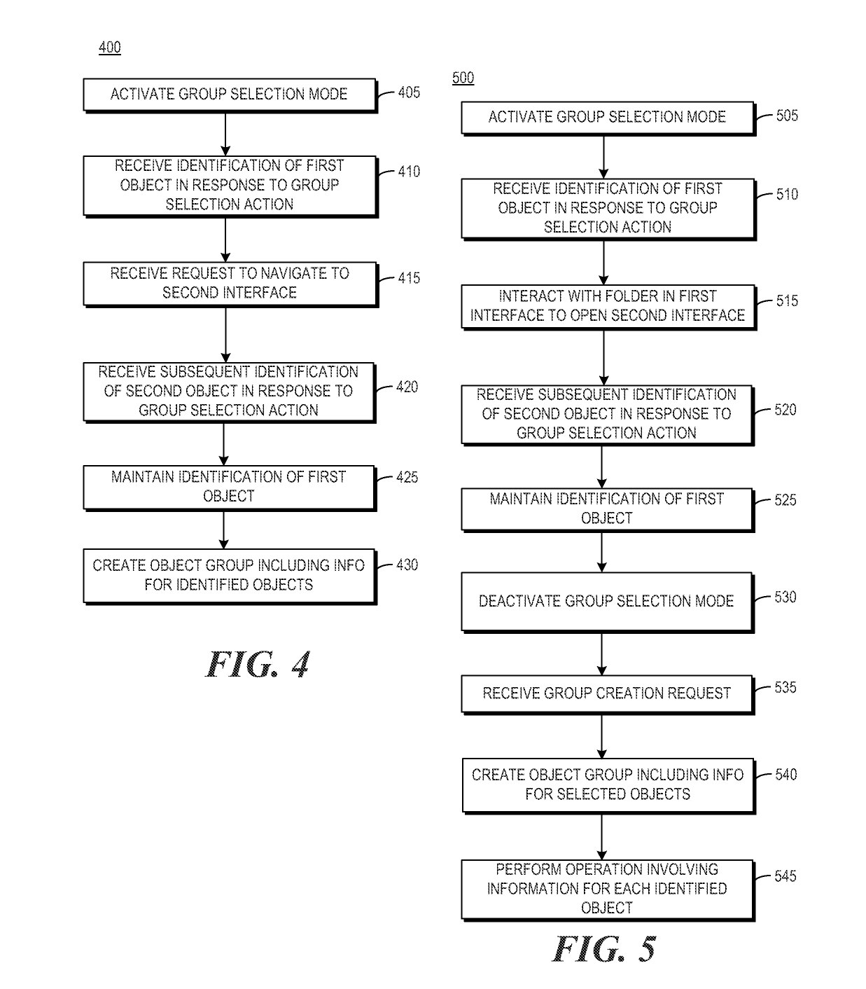

FIG. 5 is a flowchart of an example method 500 for performing an operation on an object group representing objects identified in different interfaces of a GUI. Although execution of method 500 is described below with reference to computing device 100 of FIG. 1, other suitable components for execution of method 500 can be utilized (e.g., computing device 300). Additionally, method 500 may be implemented in the form of executable instructions encoded on a machine-readable storage medium, in the form of electronic circuitry, or a combination thereof.

At 505 of method 500, computing device 100 may activate a group selection mode in response to operation of a group selection start feature of a GUI output on a display of computing device 100. At 510, computing device 100 may receive an identification of a first interface object in response to a group selection action performed, in the group selection mode, on the first interface object displayed in a first interface of the GUI. In some examples, the first interface may display a folder in addition to the first interface object. For example, as illustrated in FIG. 2B, the first interface may be a window 250 including a first interface object (e.g., file 234) and a folder 222.

At 515, computing device 100 may receive an interaction with the folder displayed in the first interface to open a second interface displaying the contents of the folder. In some examples, the contents of the folder may include a second interface object displayed in the second interface when the folder is opened. In the example illustrated in FIGS. 2B and 2C, for example, computing device 100 may receive interaction with folder 222 displayed in the first interface (e.g., window 250). In response, computing device 100 may open a second interface (e.g., window 252) displaying the contents of folder 222, including a second interface object (e.g., folder 224). In other examples, opening folder 222 to display a second interface (e.g., window 252) may cause window 252 displaying the contents of folder 222 to replace the first interface (e.g., window 250) displaying the contents of folder 220. In other examples, the first interface may be window 250 displaying the contents of folder 220, and the second interface may be window 250 displaying the contents of a different folder (e.g., folder 222).

At 520, computing device 100 may receive a subsequent identification of a second interface object in response to a group selection action performed, in the group selection mode, on the second interface object displayed in the second interface. At 525, in the group selection mode, computing device 100 may maintain the identification of the first interface object when the subsequent selection of the second interface object is received. For example, computing device 100 may maintain object information for the first interface object in a list when the second interface object displayed in the second interface is identified with a group selection action. Computing device 100 may also add object information for the second interface object to the list.

At 530, computing device 100 may deactivate the group selection mode in response to operation of a group selection end feature of the GUI of computing device 100. At 535, computing device 100 may receive a group creation request after the operation of the group selection end feature. For example, after operation of the group selection end feature, computing device 100 may receive a group creation request in response to operation of a group creation feature of the GUI, as described above in relation to FIG. 1.

At 540, in response to the group creation request, computing device 100 may create an object group including object information for the interface objects identified in the group selection mode. In some examples, the object group may include the object information maintained in the list for each identified interface object. In other examples, the object information in the list may be used to identify the selected interface objects, and other object information for the selected interface objects may be included in the object group in addition to or instead of the information included in the list.

At 545, in response to interaction with the object group, computing device 100 may perform an operation involving object information for each of the interface objects identified in the group selection mode. For example, in response to an interaction requesting that an operation be performed on the object group, computing device 100 may perform the requested operation on the object information included in the created object group. For example, in response to an interaction with the group object requesting a copy operation, an e-mail operation, or the like, the object information included in the object group, which includes object information for each interface object identified in the group selection mode, may be copied, e-mailed, or the like, in accordance with the operation requested by the interaction with the object group.

What is claimed is:

1. A non-transitory machine-readable storage medium encoded with instructions executable by a processor of a computing device, the storage medium comprising:
instructions to activate a group selection mode in response to operation of a group selection start feature of a graphical user interface (GUI) of the computing device;
instructions to receive respective interactions with a plurality of interface objects in the group selection mode, the interactions in the group selection mode identifying interface objects to be represented in a group, wherein at least two of the interface objects are displayed in different interfaces of the GUI; and
instructions to create, in response to a group creation request, an object group including object information for the interface objects identified, in the group selection mode, to be represented in a group.

2. The storage medium of claim 1, wherein each of the respective interactions with the interface objects is a group selection action performed on one of the interface objects, wherein the group selection action is different than each navigation action of the GUI.

3. The storage medium of claim 1, wherein the instructions to create comprise:
instructions to deactivate the group selection mode in response to operation of a group selection end feature of the GUI; and
instructions to receive the group creation request in response to operation of a group creation feature of the GUI.

4. The storage medium of claim 1, wherein the instructions to activate comprise:
instructions to request selection of an object group type in response to the operation of the group selection start feature.

5. The storage medium of claim 4, wherein the instructions to receive comprise:
instructions to receive respective interactions with each of the interface objects of a type associated with a selected object group type; and
instructions to ignore respective interactions with each of the interface objects of a type not associated with the selected object group type.

6. The storage medium of claim 4, wherein the instructions to receive comprise:
instructions to store, in response to each of the respective interactions with one of the interface objects, a textual aspect of the interface object, if a selected object group type is a text group.

7. A computing device comprising:
a display to output a graphical user interface (GUI);
an activation module to activate a group selection mode in response to operation of a group selection start feature of the GUI;
a selection receipt module to receive an interaction with a first interface object displayed in a first interface of the GUI in the group selection mode, and a subsequent interaction with a second interface object displayed in a second interface of the GUI in the group selection mode, the interactions in the group selection mode identifying interface objects to be represented in a group;
a selection maintenance module to maintain object information for the first interface object in a list of identified interface objects when the subsequent interaction with the second interface object is received in the group selection mode; and
a creation module to create, in response to a group creation request, an object group including object information for the interface objects identified, in the group selection mode, to be represented in a group.

8. The computing device of claim 7, wherein:
each of the interactions received by the selection receipt module is a group selection action performed on one of the interface objects;
the group selection action is different than each navigation action of the GUI; and
the group selection action is performed via a single input device.

9. The computing device of claim 8, wherein:
the display is a touch-sensitive display, and the group selection action includes a held touch action input via the touch-sensitive display.

10. The computing device of claim 7, wherein:
the first interface is a window displaying the contents of a first folder including the first interface object and a second folder; and
the second interface is a window displaying the contents of the second folder including the second interface object.

11. The computing device of claim 7, wherein:
the first interface is a window displaying the contents of a folder including the first interface object; and
the second interface is a desktop of the GUI including the second interface object.

12. The computing device of claim 7, wherein:
the first interface is an interface for a first application in which the first interface object is displayed; and
the second interface is an interface for a second application in which the second interface object is displayed.

13. A method comprising:
activating a group selection mode in response to operation of a group selection start feature of a graphical user interface (GUI) of a computing device;
receiving an identification of a first interface object in response to a group selection action performed, in the group selection mode, on the first interface object displayed in a first interface of the GUI;
receive a request to navigate to a second interface of the GUI;
receiving a subsequent identification of a second interface object in response to a group selection action performed, in the group selection mode, on the second interface object displayed in the second interface;
maintaining the identification of the first interface object, in the group selection mode, when the subsequent identification of the second interface object is received; and
creating, in response to a group creation request, an object group including object information for the interface objects identified in the group selection mode.

14. The method of claim 13, wherein the request to navigate to the second interface comprises receiving an interaction with a folder displayed in the first interface to open the second interface, wherein the contents of the folder, including the second interface object, are displayed in the second interface.

15. The method of claim 14, further comprising:
deactivating the group selection mode in response to operation of a group selection end feature;
receiving the group creation request after the operation of the group selection end feature; and
performing, in response to interaction with the object group, an operation involving the object information for each of the interface objects identified in the group selection mode.
